(19) United States
(12) Patent Application Publication
(10) Pub. No.: US 2004/0206252 A1
(43) Pub. Date: Oct. 21, 2004

(54) Automatic device for pressing packs

(76) Inventor: Jean-Michel Egretier, Coursan (FR)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/475,951

(22) PCT Filed: Apr. 11, 2002
(86) PCT No.: PCT/FR02/01260

(30) Foreign Application Priority Data
Apr. 26, 2001 (FR) 01/05838
Feb. 1, 2002 (FR) 02/01356

(51) Int. Cl. B30B 9/06; B30B 9/04; B30B 9/02; B30B 15/00

(52) U.S. Cl. 100/131; 100/110; 100/126

(57) ABSTRACT

The invention concerns a device for pressing packs or bulk containers for recuperating liquids, in particular milk or fruit juice, which they contain. The inventive device is essentially characterised in that it comprises, in combination, a support plate (3), whereon are set the packs to be pressed (4), adapted to take up a high position for pressing the stacked packs (4) and a low position for pressuring the containers; a pressing plate (1), driven in a vertical reciprocating movement, adapted to press said packs or containers and means (2) adapted to delimit, with the plate (1) and the plate (3), a closed volume during the entire pressing phase. The means 82) is a sliding skirt, urged to be supported on the plate (3) when the packs (4) are pressed and a tank, delimited in its base by the plate (3), when the bulk containers are pressed.

The invention refers to an automatic device for pressing out in bulk packs or containers designed to recover liquids, namely milk or fruit juice they contain.

In bottling plants very often lots of packs or containers, sometimes very important have to be destroyed due to labelling or printing errors.

Current operations which are fully manual consist in recovering the liquids and destroying the empty packs or containers. Such operations are long and disturbing and the rate of liquid recovery is not satisfactory.

The invention relates to an automatic device for pressing out such packs or containers which overcomes above drawbacks.

The automatic device, according to the invention is essentially characterized in that it includes, combined, a supporting tray on which the packs and containers to be pressed out are resting, adapted for taking a high position for pressing out packs and a low position for pressing out containers; a pressing out tray, having an upright to and fro motion, adapted for pressing out such packs or containers and a means adapted for delimiting, with the pressing tray and the supporting tray, a closed volume throughout the pressing out step.

According two variations of embodiment of the invention, the means adapted for delimiting a closed volume is:

a skirt driven by the pressing out tray and adapted when it is contacting an element of the working surface located in an extension of the supporting tray at a high position, to slide with respect to the tray so that it keeps the packs pressing out volume closed until the end of the pressing out operation;

a tank delimited at Rs bottom by the supporting tray in low position and adapted to keep the containers pressing out volume closed until the end of such operation.

With such device, up to 99.5% liquid can be recovered.

The characteristics and advantages of the invention will be clearer from the detailed description below of at least one preferred embodiment of that given as a non limiting example arid illustrated In the appended drawings. In such drawings:

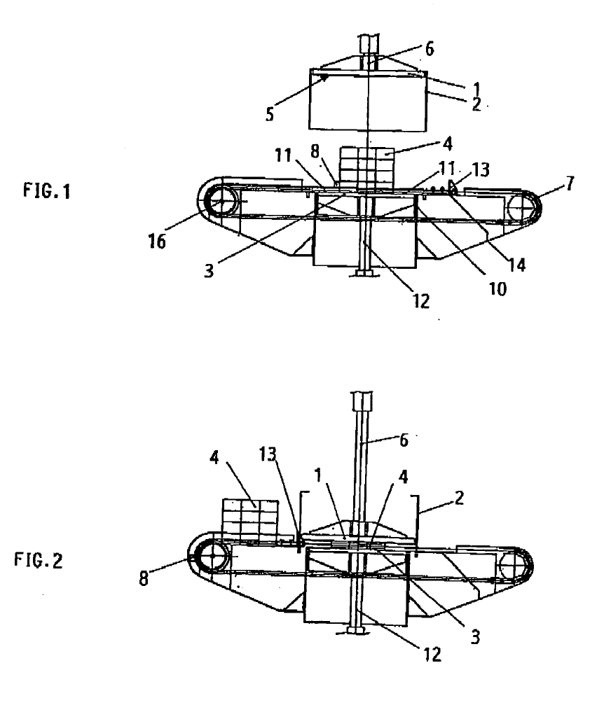

FIG. 1 is a sectional view of the device according to the invention in the case of stacked packs (pressing out tray at a high position associated to a skirt);

FIG. 2 is a sectional view of such device, pressing out tray at a low position;

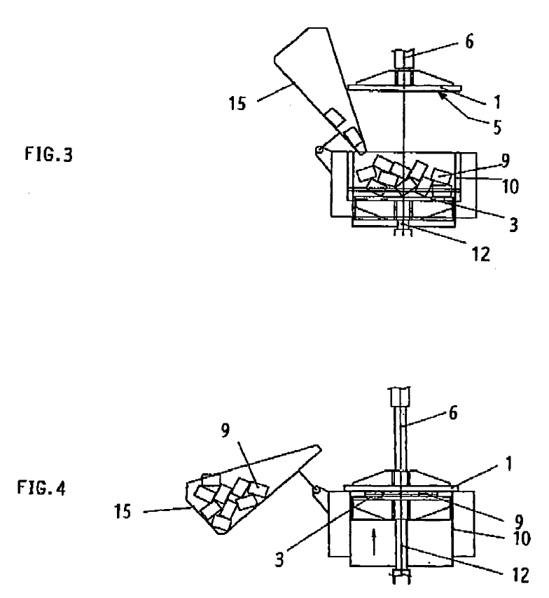

FIG. 3 is a sectional view of the device according to the invention in the case of in bulk containers (pressing out tray in high position associated to a tank);

FIG. 4 is a sectional view of such device, pressing out tray at a low position;

The device illustrated in the figures comprise, combined, a supporting tray (3) on which are resting the packs (4) or containers (9) to be pressed out, adapted for taking a high position for pressing out packs (4) and a low position for pressing out containers (9); a pressing out tray (1) haying an upright to and fro motion, adapted for pressing out such packs or containers and a means (2, 10) adapted for delimiting, with the tray (1) and the support (3), a closed volume throughout the pressing out step.

According to two variations of embodiment of the invention:—the means (2) is a skirt driven by the tray (1) and adapted when It is contacting an element (11) of the working surface located in an extension of the tray (3) at a high position, to slide with respect to such tray (1) so that it keeps the packs pressing out volume (4) closed until the end of such operation;

the means (10) is a tank delimited at its bottom by the tray (3) in low position and adapted to keep the containers pressing out volume (9) closed until the end of such operation.

The tray (1) comprises on its pressing out face, a plate (5) of rubber-like matter having a thickness and a consistence adapted for moulding itself to the surface of the pressed out packs and containers surface.

Such tray (1) is driven in its to and fro motion by a screwjack means (6)and the tray (3) by an also screwjack means (12).

In the case of pressing out packs (4), the working surface (3, 11):

comprises a loading area (A) followed by a pressing out area (B) in turn followed by a dripping area (C);

is associated to a means of the kind having chains (7) and dollies (8, 13) having a to and fro motion adapted to drive the packs (4) from the loading area (A) to the dripping area (C) passing by the pressing area (B). The interval existing between the dollies (8) designed to drive the packs to be pressed out (4) from the loading area (A) to the pressing out area (B) and the dollies (13) designed to drive the pressed out packs (4) from the pressing out area (B) to the dripping area (C) is over the skirt (2) width delimiting the pressing out volume.

In the case of pressing out in bulk containers (9):

the tank (10) is fed by a (either tilting or not) hopper (15).

when the pressing out is complete, the tray (3) takes up the pressed out containers (9) which are then driven from the pressing out area (B) to the dripping area (C), by means of the dollies (13).

A tank (14) for recovering the liquids is placed under the working surface. The chains (7) are driven by pulleys (16).

Of course, the invention is not limited to the embodiments disclosed and Illustrated to which other variations can be proposed, namely in:

the nature, shapes and sizes of the trays, skirt or tank;

the means for driving the trays and the packs or containers.

1.- Devices for pressing out in bulk packs or containers designed to recover liquids, namely milk or fruit Juice they contain:
characterized in that It includes, combined, a supporting tray (3) on which the packs (4) or containers (9) to be pressed out are resting, adapted for taking a high position for pressing out packs (4) and a low position for pressing out containers (9); a pressing out tray (1), having an upright to and fro motion, adapted for pressing out such packs or containers and a means (2, 10) adapted for delimiting, with the tray (1) and the tray (3), a closed volume throughout the pressing out step.

2.- Device according to claim 1, characterized in that the means (2) is a skirt driven by the tray (1) and adapted when it is contacting an element (11) of the working surface located in an extension of the tray (3) at a high position, to slide with respect to such tray (1) so that It keeps the packs pressing out volume (4) closed until the end of such operation.

3.- Device according to claim 1, characterized in that the means (10) is a tank delimited at its bottom by the tray (3) in low position and adapted to keep the containers pressing out volume (9) closed until the end of such operation.

4.- Device according to claim 1, characterized In that the tray (1) comprises on its pressing out face, a plate (5) of rubber-like matter having a thickness and a consistence adapted for moulding itself to the surface of the pressed out packs and containers surface.

5.- Device according to claim 1, characterized in that the working surface (3, 11) comprises a loading area (A) followed by a pressing out area (B) in turn followed by a dripping area (C);

6.- Device according to claim 5, characterized in that the working surface (3, 11) is associated to a means of the kind having chains (7) and dollies (8, 13) having a to and fro motion adapted to drive the packs (4) from the loading area (A) to the dripping area (C) passing by the pressing area (B) and the containers (9) from the pressing out area (B) to the dripping area (C).

7.- Device according to claim 6, characterized in that the interval existing between the dollies (8) designed to drive the packs to be pressed out (4) from he loading area (A) to the pressing out area (B) and the dollies (13) designed to drive the pressed out packs (4) or containers (9) from the pressing out area (B) to the dripping area (C) is over the skirt (2) width delimiting the pressing out volume.

8.- Device according to claim 3, characterized in that the tank (10) is fed by a hopper (15).

9.- Device according to claims 6 and 8, characterized in that when the pressing out is complete, the tray (3) takes up the pressed out containers (9) which are then driven from the pressing out area (B) to the dripping area (C), by means of the dollies (13).

10.- Device according to claim 1, characterized in that a tank (14) for recovering the liquids is placed under the working surface.
